(19) United States
(12) Patent Application Publication
(10) Pub. No.: US 2025/0096720 A1
(43) Pub. Date: Mar. 20, 2025

(54) PORTABLE CLAMPING DEVICE FOR ROOF SOLAR

(71) Applicant: GUANGZHOU ISSYZONE TECHNOLOGY CO.,LIMITED, Guangzhou (CN)

(72) Inventors: ZHUO JIA, Guangzhou (CN); TAIPING YANG, Shenzhen (CN); ZHOUSHENG YANG, Guangzhou (CN)

(21) Appl. No.: 18/389,359

(22) Filed: Nov. 14, 2023

(30) Foreign Application Priority Data
Sep. 18, 2023 (CN) 202322527996.9

(51) Int. Cl. H02S 20/23; F16M 13/02

(52) U.S. Cl. CPC H02S 20/23; F16M 13/022

(57) ABSTRACT

The present disclosure provides a portable clamping device for installation a roof solar including a roof crossbar, where a solar panel is provided thereon. The solar panel and the roof crossbar are connected by a first clamping component, a second clamping component, a third clamping component, and a fourth clamping component in four different ways. The second clamping component can be freely locked at any position on an edge of the solar panel. The first clamping component can be set to achieve clamping various different shapes of crossbars. The third clamping component can be set to render the disassembly to be simple, nylon is used to enhance a toughness of a clamp. The entire device uses three different clamping modes to suit for clamping the roof solar panel, thereby ensuring a practicality of the entire device.

### CROSS-REFERENCE TO RELATED APPLICATIONS

This application claims priority to Chinese Patent Application No. 202322527996.9, filed on Sep. 18, 2023, which is hereby incorporated by reference in its entirety.

### TECHNICAL FIELD

The present disclosure relates to the field of clamping technologies, and in particular, to a portable clamping device for installation a roof solar.

### BACKGROUND

Solar energy is a renewable energy source that is ubiquitous, inexhaustible, and inexhaustible. With the increasing demand for outdoor electricity, the demand for outdoor electricity is also increasing. The demand for using solar panels on the roof to power or illuminate equipment is also constantly changing, and the demand is constantly increasing.

The disadvantages of installing an existing solar panel are: 1. the solar panel are all fixed on the crossbar or on the slide rail with screws, rendering disassembly and cleaning inconvenient; 2. the use of screws for fixation is limited by the crossbar and cannot be adjusted; 3. the installation is single, and it is not convenient to switch usage scenarios after installation; 4. the installation compatibility of solar panels on the market is poor, and a portable clamping device for installing a roof solar is needed to solve this problem.

### SUMMARY

The purpose of the present disclosure is to provide a portable clamping device for installation a roof solar, in order to solve the problems in the above-mentioned technology.

To achieve the above objectives, the present disclosure provides the following technical solution: a portable clamping device for installation a roof solar including a roof crossbar, where the roof crossbar is provided with a solar panel thereon, and the solar panel and the roof crossbar are connected by a first clamping component, a second clamping component, a third clamping component, and a fourth clamping component in four different ways.

In an embodiment of the present disclosure, the first clamping component is provided with a fixed block, the fixed block is provided with a first positioning frame, the fixed block is provided with a push plate therein; and two ends of the push plate are installed with a clip.

In an embodiment of the present disclosure, an adjustment screw is provided between the fixed block and the first positioning frame; the fixed block is threaded-connection with the first positioning frame by the adjustment screw, and the adjustment screw runs through the fixed block and the push plate, and the first positioning frame is threaded-connection with a first threaded rod, a bottom end of the first threaded rod is fixedly installed with a first positioning disc.

In an embodiment of the present disclosure, the second clamping component is composed of an upper end portion and a lower end portion, respectively; the upper end portion and the lower end portion are connected by a connection member; the upper end portion is provided with a notching; connection members that are sleeved inside the notching are connected through a movable shaft that runs through and rotates the connection members; and one ends of the upper end portion and lower end portion are locked by a thread of a rotatable screw element.

In an embodiment of the present disclosure, the upper end portion is provided with a second positioning frame thereon, and a side end of the second positioning frame is fixedly installed with a sheet metal part, the sheet metal part is locked with the solar panel through a thread of a screw.

In an embodiment of the present disclosure, the third clamping component is provided with a third positioning frame thereon; the third positioning frame is installed with a T-shaped screw thereon; the third positioning frame is threaded and locked with the roof crossbar through the T-shaped screw.

In an embodiment of the present disclosure, the third positioning frame is installed with a second threaded rod thereon; and a bottom end of the second threaded rod is fixedly installed with a second positioning disc.

In an embodiment of the present disclosure, the fourth clamping component is installed with a support frame thereon; and the support frame is rotationally connected with a movable shaft component; one end of the movable shaft component is rotationally connected with an adjustment member, and one end of the adjustment member is rotationally connected with an interconnection piece through a rotating shaft; a limit member on the interconnection piece runs through the interconnection piece, and a clamp sleeve is installed between the limit member and the interconnection piece, and the clamp sleeve is locked with the limit member through a nut.

In an embodiment of the present disclosure, a bottom end of the support frame is fixedly provided with a limit block, and the limit block is provided with a positioning hole.

Compared with the existing technology, the present disclosure has the following beneficial effects:
the present disclosure is a portable clamping device for installation a roof solar, which is designed to lock small sheet metal parts with the solar panel. The sheet metal parts can be installed on holes on the solar panel or can be freely locked at any position on an edge of the solar panel to adapt to any size of the solar panel. A unique first clamping component is designed, and this structure can clamp various different shapes of crossbars commonly used in the market, such as elliptical, square, and circular shapes. The third clamping component is set to render disassembly and assembly simple, and which can be achieved with only one screw. It is convenient and fast to use. The fourth clamping component is set to clamp the solar panel by pulling a clamp, which is faster than screw locking in disassembly and assembly. The accessories of the clamping component are made of steel plates to ensure the strength of the structure, Nylon is used to enhance a toughness of the clamp, thereby ensuring that users can safely use the product on the roof. An entire device adopts three different clamping modes suitable for clamping the roof solar panel, and therefore ensuring a practicality of the entire device.

### BRIEF DESCRIPTION OF DRAWINGS

In order to provide a clearer explanation of the embodiments of the present disclosure or the technical solutions in the prior art, a brief introduction will be given to the drawings required in the embodiments. It is obvious that the drawings in the following description are only some embodiments of the present disclosure. For ordinary technical personnel in the art, other drawings can be obtained based on these drawings without any creative work.

FIG. 1 is a schematic diagram of a first clamping structure of a portable clamping device for installation a roof solar according to an embodiment of the present disclosure.

FIG. 2 is a structural schematic diagram of a first clamping component of the portable clamping device for installation a roof solar according to an embodiment of the present disclosure.

FIG. 3 is a plan view of the first clamping component of the portable clamping device for installation a roof solar according to the embodiment of the present disclosure,

FIG. 4 is a schematic diagram of a second clamping structure of the portable clamping device for installation a roof solar according to an embodiment of the present disclosure.

FIG. 5 is a bottom view of the second clamping structure of the portable clamping device for installation a roof solar according to an embodiment of the present disclosure.

FIG. 6 is a schematic diagram of an enlarged structure at position A in FIG. 4 of the present disclosure.

FIG. 7 is a schematic diagram of a third clamping structure of the portable clamping device for installation a roof solar according to an embodiment of the present disclosure.

FIG. 8 is a structural schematic diagram of the first clamping component of the portable clamping device for installation a roof solar according to the embodiment of the present disclosure.

FIG. 9 is a schematic diagram of a fourth clamping structure of the portable clamping device for installation a roof solar according to an embodiment of the present disclosure.

FIG. 10 is a schematic diagram of an enlarged structure at position A in FIG. 9 of the present disclosure.

Numeral reference: 1. Roof crossbar; 2. Solar panel; 3. First clamping component; 4. Fixed block; 5. First positioning frame; 6. Adjustment screw; 7. First threaded rod; 8. First positioning disc; 9. Clip; 10. Push plate; 11. Second clamping component; 12. Screw; 13. Sheet metal part; 14. Second positioning frame; 15. Upper end portion; 16. Lower end portion; 17. Connection member; 18. Movable shaft; 19. Notching; 20. Rotatable screw element; 21. Third clamping component; 22. Third positioning frame; 23. Second positioning disc; 24. Second threaded rod; 25. T-shaped screw; 26. Limit block; 27. Positioning hole; 28. Support frame; 29. Adjustment member; 30. Movable shaft component; 31. Interconnection piece; 32. Clamp sleeve; 33. Limit member; 34. Nut; 35. Fourth clamping component.

### DESCRIPTION OF EMBODIMENTS

Below, combined with the drawings and specific embodiments, a further description of the present disclosure will be provided.

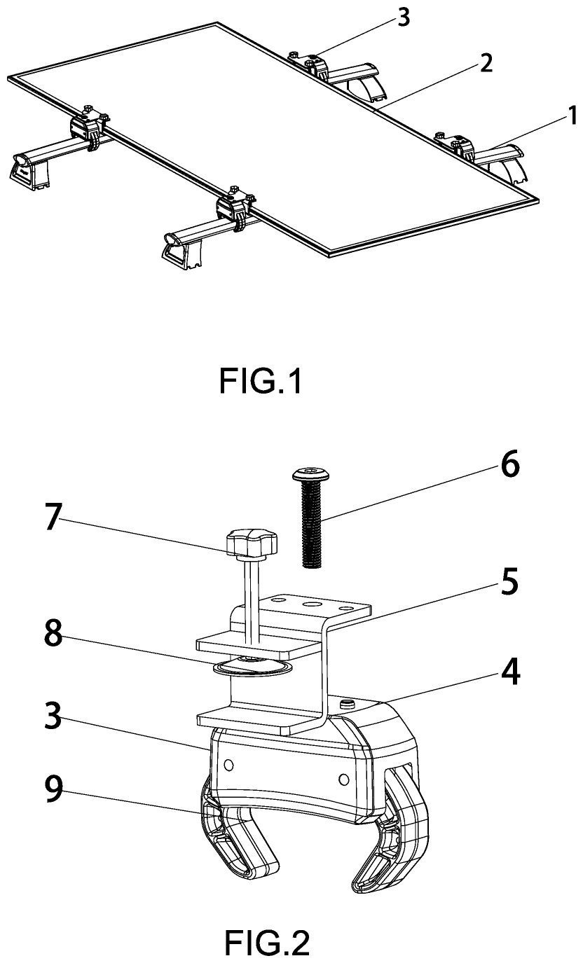

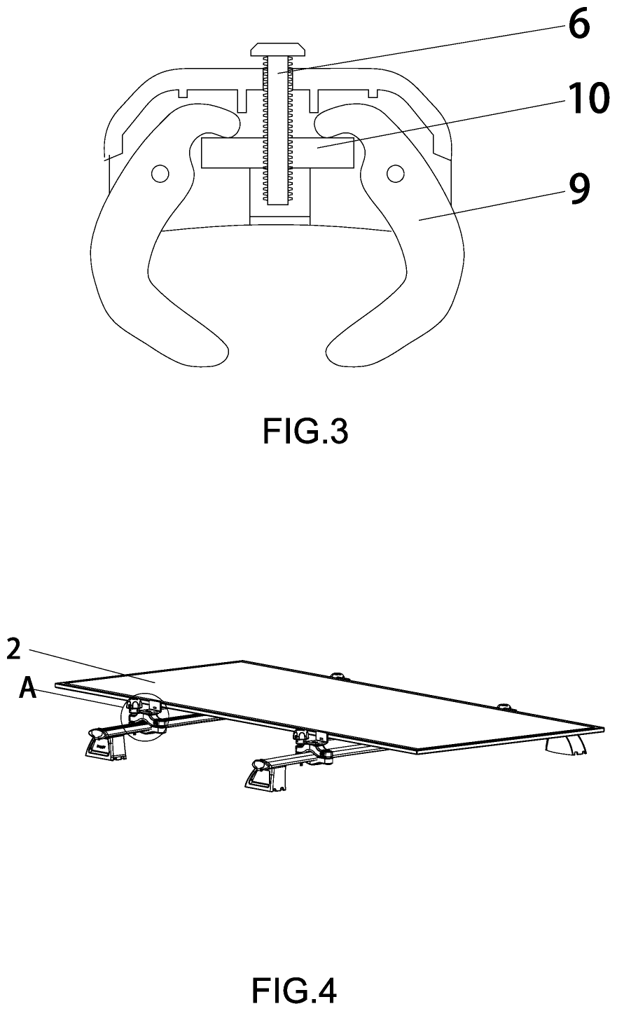

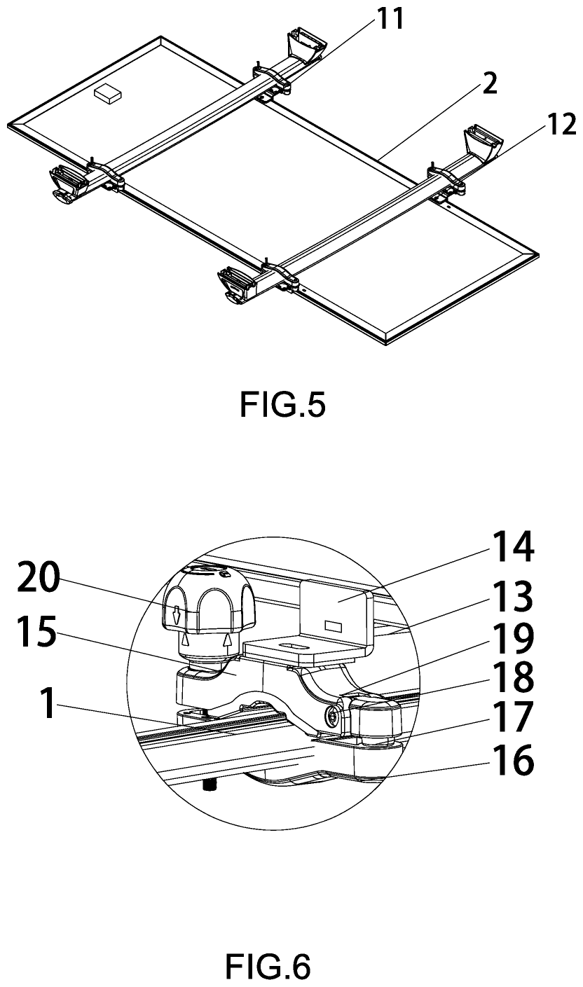

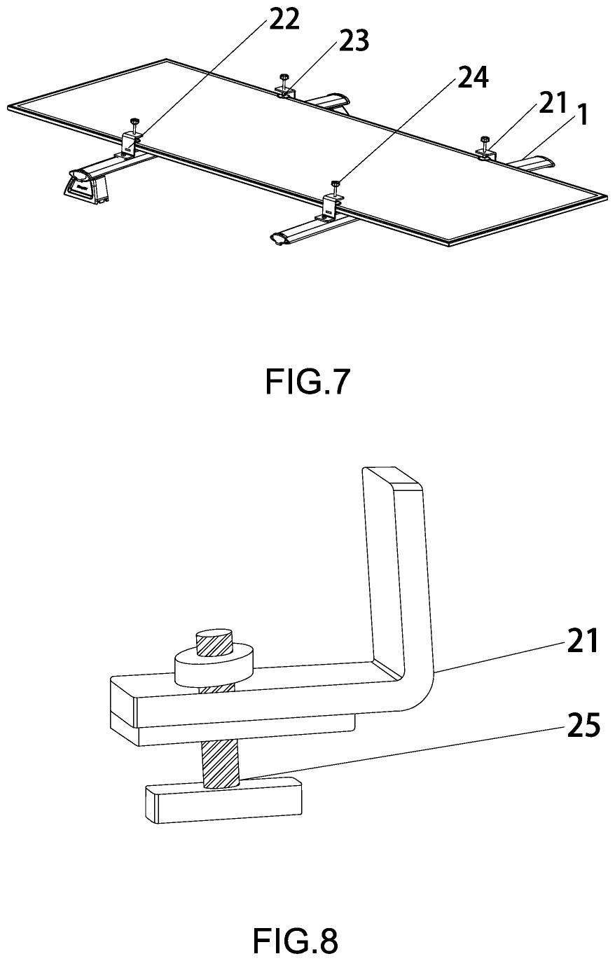

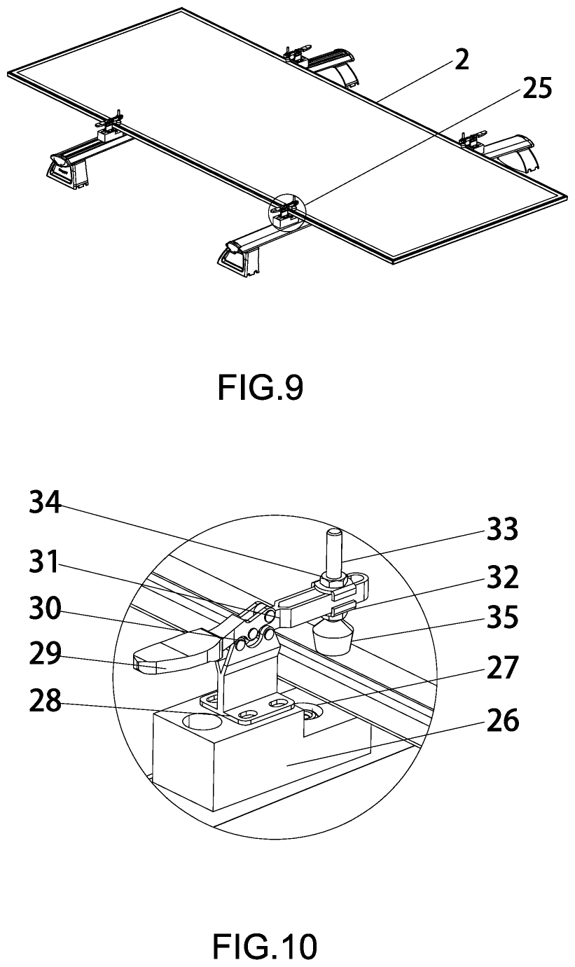

Please refer to FIGS. 1-10. According to an embodiment of the present disclosure, a portable clamping device for installation a roof solar includes a roof crossbar 1, the roof crossbar 1 is provided with a solar panel 2 thereon. The solar panel 2 and the roof crossbar 1 are connected through by a first clamping component 3, a second clamping component 11, a third clamping component 21, and a fourth clamping component 35 in four different ways.

In this embodiment, the first clamping component 3 is provided with a fixed block 4, the fixed block 4 is provided with a first positioning frame 5, the fixed block 4 is provided with a push plate 10 therein; and two ends of the push plate 10 are installed with a clip 9. An adjustment screw 6 is provided between the fixed block 4 and the first positioning frame 5; the fixed block 4 is threaded-connection with the first positioning frame 5 by the adjustment screw 6, and the adjustment screw 6 runs through the fixed block 4 and the push plate 10, and the first positioning frame 5 is threaded-connection with a first threaded rod 7, a bottom end of the first threaded rod 7 is fixedly installed with a first positioning disc 8.

Where, the design of the first clamping component 3 can achieve clamping various different shapes of crossbars commonly used on the market, such as elliptical, square, and circular, suitable for different types of roof crossbars 1.

In this embodiment, the second clamping component 11 is composed of an upper end portion 15 and a lower end portion 16, respectively; the upper end portion 15 and the lower end portion 16 are connected by a connection member 17; the upper end portion 15 is provided with a notching 19; connection members 17 that are sleeved inside the notching 19 are connected through a movable shaft 18 that runs through and rotates the connection members 17; and one ends of the upper end portion 15 and lower end portion 16 are locked by a thread of a rotatable screw element 20. The upper end portion 15 is provided with a second positioning frame 14 thereon, and a side end of the second positioning frame 14 is fixedly installed with a sheet metal part 13, the sheet metal part 13 is locked with the solar panel 2 through a thread of a screw 12.

Where, the sheet metal part 13 on the second clamping component 11 can be installed on hole on the solar panel 2, or can be freely locked at any position on an edge of the solar panel 2 to adapt to any size of the solar panel 2.

In this embodiment, the third clamping component 21 is provided with a third positioning frame 22 thereon; the third positioning frame 22 is installed with a T-shaped screw 25 thereon; the third positioning frame 22 is threaded and locked with the roof crossbar 1 through the T-shaped screw 25. The third positioning frame 22 is installed with a second threaded rod 24 thereon; and a bottom end of the second threaded rod 24 is fixedly installed with a second positioning disc 23.

Where, the setting and disassembly of the third clamping component 21 is simple, and can be achieved with just one screw, thereby rendering it convenient and fast to use.

In this embodiment, the fourth clamping component 35 is installed with a support frame 28 thereon; and the support frame 28 is rotationally connected with a movable shaft component 30; one end of the movable shaft component 30 is rotationally connected with an adjustment member 29, and one end of the adjustment member 29 is rotationally connected with an interconnection piece 31 through a rotating shaft; a limit member 33 on the interconnection piece 31 runs through the interconnection piece 31, and a clamp sleeve 32 is installed between the limit member 33 and the interconnection piece 31; the clamp sleeve 32 is locked with the limit member 33 through a nut 34. A bottom end of the support frame 28 is fixedly provided with a limit block 26, and the limit block 26 is provided with a positioning hole 27.

Where, the setting of the fourth clamping component 35 uses a way of pulling a clamp to clamp the solar panel 2, which is more rapid in disassembly and assembly compared to screw locking.

In a specific application, the clamping device is designed to lock small sheet metal parts with the solar panel. Sheet metal part 13 can be installed on the holes on solar panel 2, or can be freely locked at any position on the edge of solar panel 2 to adapt to any size of solar panel 2. In this way, by a rotation connection way of one end of the upper end portion 15 and one end of the lower end portion 16, and a way that the other end of the upper end portion 15 and the other end of the lower end portion 16 are locked by the rotation of the rotatable screw element (20), so that different sizes of roof crossbars 1 are clamped and ensure a stability of the roof crossbar 1. A unique first clamping component 3 is designed, which can clamp various different shapes of crossbars commonly used in the market, such as elliptical, square, and circular. By turning the adjustment screw 6 clockwise, the push plate 10 is driven by the adjustment screw 6, and the push plate 10 abuts against the clamp 9; thus, the clamping of the roof crossbar 1 is achieved by clamping the crossbar. The third clamping component 21 is set to facilitate disassembly and assembly, which can be achieved with just one screw. It is convenient and fast to use. The fourth clamping component 35 is set to clamp the solar panel 2 by pulling the clamp, which is faster than screw locking. The position of the interconnection piece 31 is adjusted by adjusting the adjustment member 29. The solar panel 2 is clamped by the limit member 33, the limit member 33 is locked by the clamp sleeve 32 and the nut 34. By loosening the nut, the position of the limit member 33 on the interconnection piece 31 can be achieved, thereby improving the adjustability of the limit member 33 and ensuring stable clamping. The accessories of the clamping component are made of steel plates to ensure the strength of the structure, Nylon is used to enhance a toughness of the clamp, thereby ensuring that users can safely use the product on the roof. An entire device adopts three different clamping modes suitable for clamping the roof solar panel 2, and therefore ensuring a practicality of the entire device.

In the description of the present disclosure, it should be noted that terms “top”, “bottom”, “one side”, “other side”, “front”, “back”, “middle position”, “interior”, “top”, “bottom”, etc. indicate an orientation or a position relationship based on the orientation or position relationship shown in drawings, only for a convenience of describing the present disclosure and simplifying the description, rather than indicating or implying that the device or component referred to must have a specific orientation, be constructed and operated in a specific orientation, therefore it cannot be understood as a limitation on the present disclosure. Terms “first”, “second”, and “third” are only used to describe a purpose and cannot be understood as indicating or implying a relative importance. In addition, unless otherwise specified and limited, terms “installation”, “connection with”, and “connection to” should be understood broadly, for example, they can be a fixed connection, a detachable connection, or an integrated connection; it can be a mechanical connection or an electrical connection; it can be a directly connection, or an indirectly connection through an intermediate medium, or it can be an internal connection between two components. For ordinary technical personnel in this field, a specific meaning of the above terms in the present disclosure can be understood in a specific situation.

Finally, it should be noted that the above is only a preferred embodiment of the present disclosure and is not intended to limit it. Although the present disclosure has been described in detail with reference to the aforementioned embodiments, for those skilled in the art, they can still modify the technical solutions recorded in the aforementioned embodiments or substitute some of their technical features equivalently. Any modifications, equivalent substitution, improvements, etc. made within the spirit and principles of the present disclosure shall be included in the protection scope of the present disclosure.

What is claimed is:

1. A portable clamping device for installation a roof solar, comprising a roof crossbar (1), the roof crossbar (1) is provided with a solar panel (2) thereon; wherein the solar panel (2) and the roof crossbar (1) are connected by a first clamping component (3), a second clamping component (11), a third clamping component (21), and a fourth clamping component (35) in four different ways.

2. The portable clamping device for installation a roof solar according to claim 1, wherein the first clamping component (3) is provided with a fixed block (4), the fixed block (4) is provided with a first positioning frame (5), the fixed block (4) is provided with a push plate (10) therein; and two ends of the push plate (10) are installed with a clip (9).

3. The portable clamping device for installation a roof solar according to claim 2, wherein an adjustment screw (6) is provided between the fixed block (4) and the first positioning frame (5); the fixed block (4) is threaded-connection with the first positioning frame (5) by the adjustment screw (6), and the adjustment screw (6) runs through the fixed block (4) and the push plate (10), and the first positioning frame (5) is threaded-connection with a first threaded rod (7), a bottom end of the first threaded rod (7) is fixedly installed with a first positioning disc (8).

4. The portable clamping device for installation a roof solar according to claim 1, wherein the second clamping component (11) is composed of an upper end portion (15) and a lower end portion (16), respectively; the upper end portion (15) and the lower end portion (16) are connected by a connection member (17); the upper end portion (15) is provided with a notching (19); connection members (17) that are sleeved inside the notching (19) are connected through a movable shaft (18) that runs through and rotates the connection members (17); and one ends of the upper end portion (15) and lower end portion (16) are locked by a thread of a rotatable screw element (20).

5. The portable clamping device for installation a roof solar according to claim 4, wherein the upper end portion (15) is provided with a second positioning frame (14) thereon, and a side end of the second positioning frame (14) is fixedly installed with a sheet metal part (13), the sheet metal part (13) is locked with the solar panel (2) through a thread of a screw (12).

6. The portable clamping device for installation a roof solar according to claim 1, wherein the third clamping component (21) is provided with a third positioning frame (22) thereon; the third positioning frame (22) is installed with a T-shaped screw (25) thereon; the third positioning frame (22) is threaded and locked with the roof crossbar (1) through the T-shaped screw (25).

7. The portable clamping device for installation a roof solar according to claim 6, wherein the third positioning frame (22) is installed with a second threaded rod (24) thereon;
and a bottom end of the second threaded rod (24) is fixedly installed with a second positioning disc (23).

8. The portable clamping device for installation a roof solar according to claim 1, wherein the fourth clamping component (35) is installed with a support frame (28) thereon; and the support frame (28) is rotationally connected with a movable shaft component (30); one end of the movable shaft component (30) is rotationally connected with an adjustment member (29), and one end of the adjustment member (29) is rotationally connected with an interconnection piece (31) through a rotating shaft; a limit member (33) on the interconnection piece (31) runs through the interconnection piece (31), and a clamp sleeve (32) is installed between the limit member (33) and the interconnection piece (31), and the clamp sleeve (32) is locked with the limit member (33) through a nut (34).

9. The portable clamping device for installation a roof solar according to claim 8, wherein a bottom end of the support frame (28) is fixedly provided with a limit block (26), and the limit block (26) is provided with a positioning hole (27).
